(19) United States
(12) Patent Application Publication
(10) Pub. No.: US 2019/0258589 A1
(43) Pub. Date: Aug. 22, 2019

(54) STORAGE DEVICE INCLUDING ONLY OWNER-WRITABLE BOOT AREA

(71) Applicant: SECURITYPLATFORM, Seongnam-si (KR)

(72) Inventors: Kyung Mo KIM, Seongnam-si (KR); Yong Kwan PARK, Seongnam-si (KR)

(21) Appl. No.: 16/344,895

(22) PCT Filed: Apr. 26, 2017
(86) PCT No.: PCT/KR2017/004410

§ 371 Date: Apr. 25, 2019

(30) Foreign Application Priority Data
Oct. 25, 2016 (KR) 10-2016-0139524

(51) Int. Cl. G06F 12/14; G06F 21/57

(52) U.S. Cl. CPC G06F 12/1408; G06F 21/572; G06F 2212/2022; G06F 2221/033; G06F 2212/1052; G06F 12/1466

(57) ABSTRACT

A storage device including an only owner-writable boot area includes: a controller controlling reading and writing; a first flash memory for storing a boot file; and a second flash memory for storing data other than the boot file and the controller includes a security unit for storing a public key of an owner, a reader unit for reading the data recorded in the first flash memory and the second flash memory, a first recording unit for recording only a boot file verified by the public key stored in the security unit in the first flash memory, and a second recording unit for recording the data in the second flash memory.

### TECHNICAL FIELD

The present invention relates to security of a device, and more particularly, to a storage device including a boot area of a device capable of enhancing the security of a device that may be easily exposed to arbitrary manipulation or external attack.

### BACKGROUND ART

Electronic devices are becoming gradually complicated and include a variety of information. As a result of the development of the Internet of Things and the like, one device serves as a security defect such as personal information exchange, remote operation, and the like while communicating with another device or a user.

In general, many devices include hardwareized software such as firmware. Firmware is the middle of software and hardware and may hardwareize software. That is, the firmware has high fixity and may be called a basic program or data stored in an ROM in order to increase the efficiency of the system, and in some cases, in a microcomputer, the firmware may be called a ROM in which programs are included because almost all programs are stored in the ROM.

The firmware has been used in many electronic devices because some of the hardware's functions are replaced with software and functions of the device may be controlled or improved with low cost in a very simple manner.

However, since the firmware has a software characteristic, the firmware is subject to hacking or forgery, and accordingly, a method of verifying the firmware with integrity has been developed.

In this regard, WO2014/134389 discloses a technique for “Continuation of trust for platform boot firmware”. According to Adams' invention, the device includes a processing module and a memory module, wherein the memory module includes a ROM in which a platform boot firmware is stored, and the processing module may load the platform boot firmware when the device is activated.

The platform boot firmware loads and verifies the signature of a hash table loaded from the platform boot firmware, and first loads a trusted program file by the processing module. Thereafter, the processing module loads other files from the platform boot firmware, calculates a hash for each file, and verifies whether a hash corresponding to each program file is present in the hash table. Program files with hashes in the hash table may be allowed to be executed. When no hash corresponding to the loaded program file exists in the hash table, the processing module performs platform specific security actions to prevent the device from being damaged.

However, the above method also requires the ROM and because of cost and convenience, most commercial, off-the-shelf (COTS) hardware does not support a boot ROM. Therefore, some electronic devices may not be able to secure safe booting and may be difficult to support hardware-based security with existing hardware.

### DISCLOSURE

### Technical Problem

The present invention provides a storage device capable of protecting a boot area and a booting process by implementing a security function even though there is no security module coupled in hardware.

The present invention provides a storage device including only an owner-writable boot area and a boot file which may be managed by only the owner.

The present invention provides a storage device which allows only the owner to manage the boot area to implement the security module coupled in hardware even COTS hardware that supports a micro SD card as a boot storage device.

### Technical Solution

In order to achieve the objects of the present invention, according to an exemplary embodiment of the present invention, there is provided a storage device including an only owner-writable boot area includes: a controller controlling reading and writing; a first flash memory for storing a boot file; and a second flash memory for storing data other than the boot file and the controller includes a security unit for storing a public key of an owner, a reader unit for reading the data recorded in the first flash memory and the second flash memory, a first recording unit for recording only a boot file verified by the public key stored in the security unit in the first flash memory, and a second recording unit for recording the data in the second flash memory.

The first flash memory as a part for storing a boot file may include a file or data required for booting an electrode device. In the present invention, the boot file may be general boot data, boot firmware, and the like and in some cases, may be stored in the form of an encrypted image.

Therefore, a process of signature verification or decryption of the general boot file or firmware may be omitted, namely the reader unit can do a booting process of the electrode device, just by calling the booth file stored in the first flash memory without signature verification or decryption. Otherwise, the encrypted image may be decoded every booting by using a public key or a symmetric key selected by a manufacturer or a communication company, or a device manager.

The second flash memory as a memory which is generally readable or writable may record an execution file, a system file, a document file, a media file, and the like through the second recording unit of the controller.

In the present invention, the first flash memory and the second flash memory are separately described, but the first flash memory and the second flash memory may be separated only software-wise as well as separated physically. Further, the first recording unit and the second recording unit may be separately provided, but the present invention is not limited thereto, and a case where one recording unit separately manages the first flash memory and the second flash memory may also be included in the present invention.

Further, the security unit of the controller may store only one public key and when there is the stored public key, addition of a new public key and deletion of the public key which is already stored are restricted to store only one public key. Of course, two or more unique keys may be used through programming of the controller.

When only one public key is stored, the stored public key may be restricted to be deleted only by using a corresponding secret key.

The storage device of the present invention may be used as a storage device usable for COTS hardware and may be an embedded Multi Media Card (eMMC), a micro SD, a USB storage device, a Solid State Drive (SSD), or a Hard Disk Drive (HDD).

In this specification, an owner as a person who has a just right to operate a device in which the storage device is used or to update firmware may be a device manufacturer or a person who is delegated management of firmware or the like from the manufacturer and in addition, a person that may purchase or receive and use the device from the manufacturer.

The security unit in the controller of the storage device may be provided in an empty state and the owner may store the public key corresponding to the secret key thereof in the security unit through a predetermined reader.

### Advantageous Effects

According to the storage device of the present invention, it is possible to protect the boot area and the booting process of the device by adding a function corresponding to the security module to the controller of the storage device even if there is no security module that is coupled to the electronic device in hardware.

The storage device of the present invention provides the only owner-writable boot area to allow only the owner to manage the boot file and to serve to protect the device from arbitrary manipulation or hacking of a third party.

Further, only the owner can manage the boot area to implement the security module coupled in hardware even in the COTS hardware supporting the micro SD card as the boot storage device and the security module which is mounted in the device similarly to the hardware is used, thereby safely maintaining the security against hacking from the outside.

### DESCRIPTION OF DRAWINGS

FIG. 1 is a diagram for describing a storage device according to an embodiment of the present invention.

FIG. 2 is a diagram for specifically describing a controller of FIG. 1.

### MODES OF THE INVENTION

Hereinafter, embodiments of the present invention will be described in detail with reference to the accompanying drawings, but the present invention is not limited or restricted to the embodiments. For reference, in the description, like reference numerals substantially refer to like elements, which may be described by citing contents disclosed in other drawings under such a rule and contents determined to be apparent to those skilled in the art or repeated may be omitted.

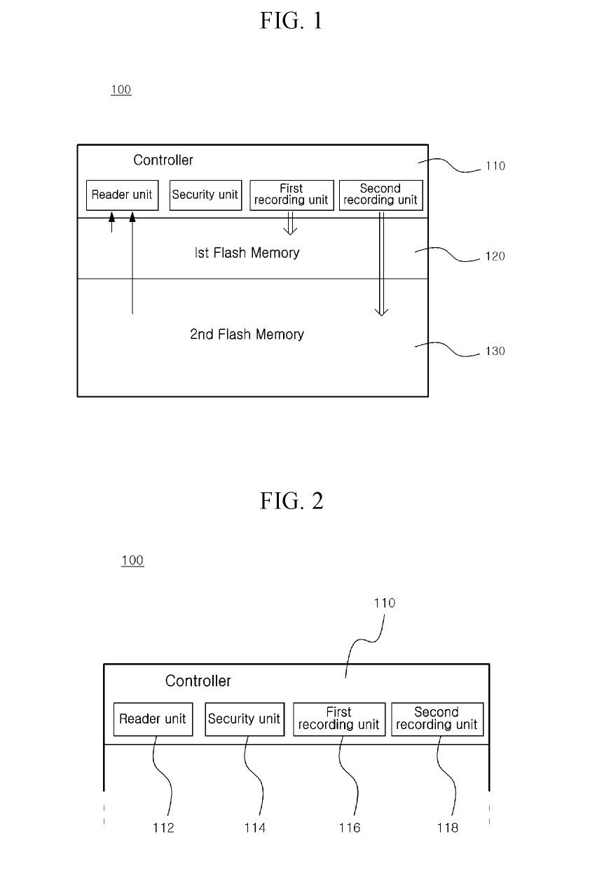

FIG. 1 is a diagram for describing a storage device according to an embodiment of the present invention and FIG. 2 is a diagram for specifically describing a controller of FIG. 1.

Referring to FIGS. 1 and 2, a storage device 100 may be described, which includes all storage devices which may grant a boot function, such as an embedded Multi Media Card (eMMC), a micro SD, a USB storage device, a solid state drive (SSD), or a hard disk drive (HDD). In the embodiment, the storage device is described with a micro SD card as a reference, but those skilled in the art may apply a configuration of a storage device having a similar function to another embodiment based on contents described below.

The storage device 100 of the embodiment may include a controller 110, a first flash memory 120 and a second flash memory 130 and the controller 110 may include a reader unit 112, a security unit 114, a first recording unit 116, and a second recording unit 118.

The controller 110 is for controlling reading and writing to and from a flash memory of the same storage device and may receive data or transmit necessary data from a mounted device (not illustrated). The controller 110 may transmit and receive data stored in the flash memory as it is and transmit and receive data through predetermined conversion or processing.

The security unit 114 of the controller 110 may store a public key of an owner. The security unit 114 may be provided without storing any unique key at the time of manufacture and the owner may store the public key corresponding to a desired private key possessed thereby through a separate reader.

According to the embodiment, the security unit 114 may store only one public key, and once the public key is stored, a third party other than the owner may restrict deletion or replacement of the public key and specifically, it is preferable that the public key is deleted by using only the secret key of the owner and a new public key may be added while the already recorded public key is deleted.

The first recording unit 116 may be provided separately from the second recording unit 118 and may verify a signature using the stored public key before storing a boot file in the first flash memory 120 and store only the verified boot file in the first flash memory 120.

Therefore, a file that may not be verified is not permitted to be recorded in a boot area, that is, the first flash memory 120 to record only a file which the owner intends to record may be recorded in the boot area. Of course, the second flash memory 130 may also be permitted to be recorded or restricted from being recorded according to setting.

The reader unit 112 may read the data in the first flash memory 120 and the second flash memory 130 and in this case, verifying the signature of the public key may not be required. However, the first flash memory 120 may store only the file verified by the security unit 114 for storing and the second flash memory 130 may store the file without verification differently from the first flash memory 120.

The boot file stored in the first flash memory 120 may be general boot data, boot firmware, and the like and in some cases, may be stored in the form of an encrypted image. Therefore, a process of signature verification or decoding of the general boot file or firmware may be omitted, but the encrypted image may be decoded every booting by using a public key or a symmetric key selected by a manufacturer or a communication company, or a device manager.

The second flash memory 130 as a memory which is generally readable or writable may record an execution file, a system file, a document file, a media file, and the like through the second recording unit of the controller.

As described above, the present invention has been described with reference to the embodiments of the present invention. However, it will be appreciated by those skilled in the art that various modifications and changes of the present invention can be made without departing from the spirit and the scope of the present invention which are defined in the appended patent claims.

1. A storage device with a boot function, which includes an only owner-writable boot area, comprising:
a controller controlling reading and writing;
a first flash memory for storing a boot file; and
a second flash memory for storing data other than the boot file,
wherein the controller includes a security unit for storing a public key of an owner,
a reader unit for reading the data recorded in the first flash memory and the second flash memory,
a first recording unit for recording only a boot file verified by the public key stored in the security unit in the first flash memory, and
a second recording unit for recording the data in the second flash memory.

2. The storage device including an only owner-writable boot area of claim 1, wherein the security unit is capable of storing only one public key and when there is the stored public key, addition of a new public key and deletion of the public key which is already stored are restricted.

3. The storage device including an only owner-writable boot area of claim 2, wherein the stored public key is able to be deleted only by using a corresponding secret key.

4. The storage device including an only owner-writable boot area of claim 1, wherein the storage device is an eMMC, a micro SD, a USB storage device, an SSD, or an HHD.
